(19) United States
(12) Patent Application Publication
(10) Pub. No.: US 2014/0374230 A1
(43) Pub. Date: Dec. 25, 2014

(54) PRESSURE SENSITIVE KEYS WITH A SINGLE-SIDED DIRECT CONDUCTION SENSOR

(71) Applicant: Microsoft Corporation, Redmond, WA (US)

(72) Inventors: Timothy C. Shaw, Sammamish, WA (US); Paul H. Dietz, Redmond, WA (US); Flavio Protasio Ribeiro, Bellevue, WA (US); Christian C. Gadke, Lake Oswego, OR (US)

(21) Appl. No.: 13/926,944

(22) Filed: Jun. 25, 2013

(51) Int. Cl. H01H 13/703; H01H 1/50; H01H 13/85; G01L 1/22

(52) U.S. Cl. CPC H01H 13/703; G01L 1/2287; H01H 1/50; H01H 13/85; H01H 2211/01
USPC 200/5 A; 73/862.627; 200/239

(57) ABSTRACT

The present disclosure describes pressure sensitive keys with a single-sided direct conduction sensor that includes a sensor substrate, a conductive layer formed on an underside of a contact layer, and a force sensing layer formed on the underside of the contact layer substantially surrounding the conductive layer. The contact layer, the conductive layer, and the force sensing layer are configured to cooperatively flex in response to an application of pressure to contact the sensor substrate.

### RELATED APPLICATIONS

The present is related to each of the following applications, which are incorporated herein by reference in their entirety:

U.S. Provisional Patent Application No. 61/606,321, filed Mar. 2, 2012, Attorney Docket Number 336082.01, and titled “Screen Edge;”

U.S. Provisional Patent Application No. 61/606,301, filed Mar. 2, 2012, Attorney Docket Number 336083.01, and titled “Input Device Functionality;”

U.S. Provisional Patent Application No. 61/606,313, filed Mar. 2, 2012, Attorney Docket Number 336084.01, and titled “Functional Hinge;”

U.S. Provisional Patent Application No. 61/606,333, filed Mar. 2, 2012, Attorney Docket Number 336086.01, and titled “Usage and Authentication;”

U.S. Provisional Patent Application No. 61/613,745, filed Mar. 21, 2012, Attorney Docket Number 336086.02, and titled “Usage and Authentication;”

U.S. Provisional Patent Application No. 61/606,336, filed Mar. 2, 2012, Attorney Docket Number 336087.01, and titled “Kickstand and Camera;” and

U.S. Provisional Patent Application No. 61/607,451, filed Mar. 6, 2012, Attorney Docket Number 336143.01, and titled “Spanaway Provisional;”

U.S. patent application Ser. No. 13/468,882, filed May 10, 2012, Attorney Docket Number 336559.01, and titled “Pressure Sensitive Keys;”

U.S. patent application Ser. No. 13/471,393, filed May 14, 2012, Attorney Docket Number 336554.01, and titled “Key Strike Determination For Pressure Sensitive Keyboard.”

U.S. patent application Ser. No. 13/470,633, filed May 14, 2012, Attorney Docket Number 336554.01, and titled “Flexible Hinge and Removable Attachment;” and

U.S. patent application Ser. No. 13/471,186, filed May 14, 2012, Attorney Docket Number 336563.01, and titled “Input Device Layers and Nesting.”

### TECHNICAL FIELD

The present disclosure pertains to pressure sensitive keys with a single-sided direct conduction sensor.

### BACKGROUND

Mobile computing devices have been developed to increase the functionality that is made available to users in a mobile setting. For example, a user may interact with a mobile phone, tablet computer, or other mobile computing device to check email, surf the web, compose texts, interact with applications, and the like. Traditional mobile computing devices often employed a virtual keyboard that was accessed using touchscreen functionality of the device. This approach was generally employed to maximize an amount of display area of the computing device.

Use of the virtual keyboard, however, could be frustrating to a user that desired to provide a significant amount of inputs, such as to enter a significant amount of text to compose a long email, document, and the like. Thus, conventional mobile computing devices were often perceived to have limited usefulness for such tasks, especially in comparison with ease at which users could enter text using a conventional keyboard, e.g., of a conventional desktop computer. Use of the conventional keyboards, though, with the mobile computing device could decrease the mobility of the mobile computing device and thus could make the mobile computing device less suited for its intended use in a mobile setting.

### SUMMARY

This Summary is provided to introduce a selection of concepts in a simplified form that are further described below in the Detailed Description. This Summary is not intended to identify key or essential features of the claimed subject matter, nor is it intended to be used to limit the scope of the claimed subject matter.

The present disclosure presents pressure sensitive keys with a single-sided direct conduction sensor. In an implementation, the pressure sensitive keys include a single-sided direct conduction sensor that, in turn, includes a sensor substrate, a conductive layer fabricated on a bottom surface of a contact layer, and a force sensing layer fabricated on the bottom surface of the contact layer substantially surrounding the conductive layer. The contact layer, the conductive layer, and the force sensing layer may be configured to cooperatively flex in response to an application of pressure to contact the sensor substrate. In an implementation, the sensor substrate may include a first conductor or a second conductor or a combination of both. The contact layer, the conductive layer, and the force sensing layer may be configured to cooperatively flex in response to the application of pressure to contact the first conductor or the second conductor or a combination of both the first conductor and the second conductor. In an implementation, the single-sided direct conduction sensor further includes a carbon layer fabricated to substantially surround the first conductor or the second conductor. A spacer layer may be configured to space apart the contact layer from the sensor substrate in an absence of the application of pressure. The force sensing layer may include a force sensing ink having a first conductivity under the application of pressure and the conductive layer may include a second conductivity higher than the first conductivity.

Additional aspects and advantages of exemplary pressure sensitive keys with a single-sided direct conduction sensor will be apparent from the following detailed description that proceeds with reference to the accompanying drawings.

### DRAWINGS DESCRIPTION

In the drawings, the left-most digit(s) of a reference number identifies the drawing figure in which the reference number first appears. The use of the same reference numbers in different instances in the description and the drawing figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to employ the techniques described herein.

FIG. 2 depicts an example implementation of an input device of FIG. 1 as showing a flexible hinge in greater detail.

FIG. 3 depicts an example implementation showing a perspective view of a connecting portion of FIG. 2 that includes mechanical coupling protrusions and a plurality of communication contacts.

FIG. 4 depicts an example of a cross-sectional view of a pressure sensitive key of a keyboard of the input device of FIG. 2.

FIG. 5 depicts an example of a pressure sensitive key of FIG. 4 as having pressure applied at a first location of a flexible contact layer to cause contact with a corresponding first location of a sensor substrate.

FIG. 6 depicts an example of the pressure sensitive key of FIG. 4 as having pressure applied at a second location of the flexible contact layer to cause contact with a corresponding second location of the sensor substrate.

FIG. 7 depicts an example of a cross-sectional view of a pressure sensitive key of a keyboard of the input device of FIG. 2.

FIG. 8A depicts an example of a cross-sectional view of a pressure sensitive key of FIG. 4 including force sensitive ink and conductors exaggerated to explain its operation.

FIG. 8B depicts an example of a cross-sectional view of the pressure sensitive key of FIG. 7 including conductive layer and force sensitive ink exaggerated to explain its operation.

FIG. 9 depicts an example layout of conductors.

FIG. 10 illustrates an example system including various components of example pressure sensitive keys that can be implemented as any type of computing device as described with reference to FIGS. 1-9 to implement embodiments of the techniques described herein.

### DETAILED DESCRIPTION

### Overview

Pressure sensitive keys may be used as part of an input device to support a relatively thin form factor, such as less than approximately 3.0 millimeters. However, pressure sensitive keys may not provide a degree of feedback that is common with conventional mechanical keyboards and therefore may result in missed hits and partial hits to intended keys of the keyboard. Further, conventional configuration of the pressure sensitive keys often resulted in different sensitivities due to the flexibility of the material being deflected, e.g., greater deflection is generally observed at a central area of the key as opposed to an edge of the key. Therefore, conventional pressure sensitive keys could result in an inconsistent user experience with a device that employs the keys.

Pressure sensitive key techniques are described. In one or more implementations, a pressure sensitive key is configured to provide a normalized output, e.g., to counteract differences in the flexibility at different positions of the pressure sensitive key. For example, sensitivity at an edge of a key may be increased in comparison with the sensitivity at a center of the key to address the differences in flexibility of the key at those positions.

The sensitivity may be adjusted in a variety of ways. For example, sensitivity may be adjusted by increasing an amount of force sensitive ink at the edges of a flexible contact layer as opposed to a center of the flexibility contact layer. In another example, an amount of conductors available to be contacted in a sensor substrate may be increased. This may be performed in a variety of ways, such as through arrangement of gaps, amount of conductive material, surface area, and so on at an edge of a sensor substrate that is contacted by the flexible contact layer as opposed to at a center of the sensor substrate.

Sensitivity may also be adjusted for different keys. For example, keys that are more likely to receive a lighter pressure (e.g., a key at a bottom row, positioned near the edges of a keyboard, and so on) may be configured to have increased sensitivity in comparison with a key that is likely to receive a higher amount of pressure, e.g., such as keys in a home row. In this way, normalization may also be performed between keys of a keyboard as well as at the keys themselves. Further discussion of these and other features may be found in relation to the following sections.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

### Example Environment

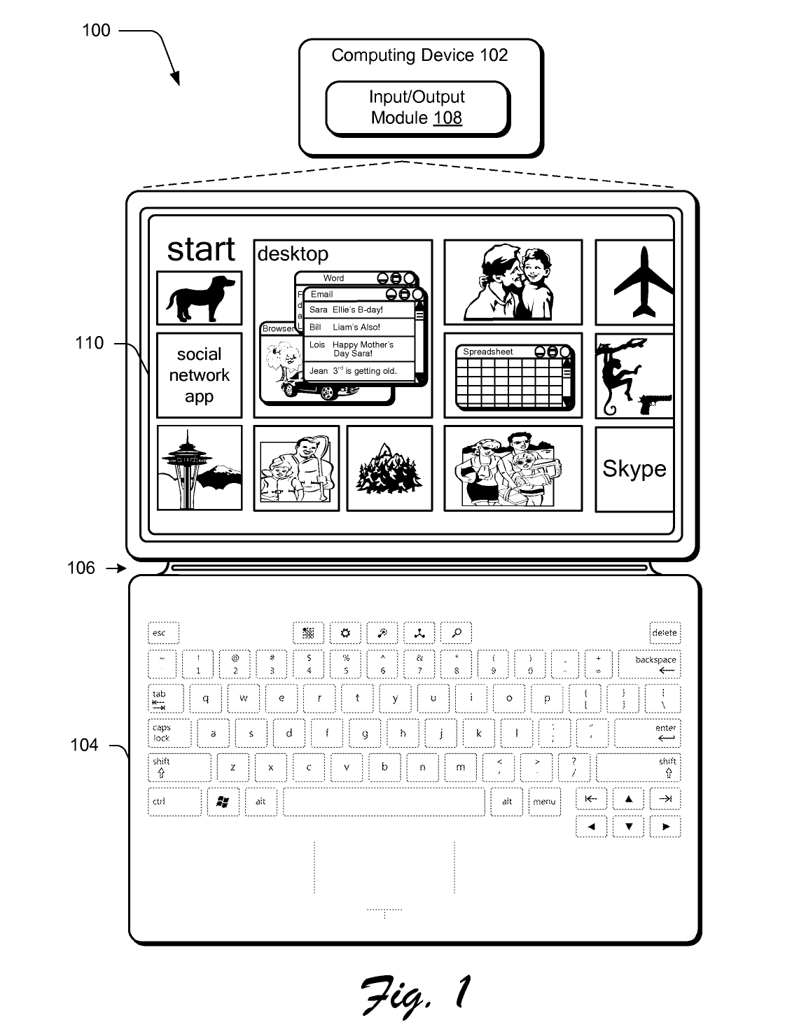

FIG. 1 is an illustration of an environment 100 in an example implementation that is operable to employ the techniques described herein. The illustrated environment 100 includes an example of a computing device 102 that is physically and communicatively coupled to an input device 104 via a flexible hinge 106. The computing device 102 may be configured in a variety of ways. For example, the computing device 102 may be configured for mobile use, such as a mobile phone, a tablet computer as illustrated, and so on. Thus, the computing device 102 may range from full resource devices with substantial memory and processor resources to a low-resource device with limited memory and/or processing resources. The computing device 102 may also relate to software that causes the computing device 102 to perform one or more operations.

The computing device 102, for instance, is illustrated as including an input/output module 108. The input/output module 108 is representative of functionality relating to processing of inputs and rendering outputs of the computing device 102. A variety of different inputs may be processed by the input/output module 108, such as inputs relating to functions that correspond to keys of the input device 104, keys of a virtual keyboard displayed by the display device 110 to identify gestures and cause operations to be performed that correspond to the gestures that may be recognized through the input device 104 and/or touchscreen functionality of the display device 110, and so forth. Thus, the input/output module 108 may support a variety of different input techniques by recognizing and leveraging a division between types of inputs including key presses, gestures, and so on.

In the illustrated example, the input device 104 is configured as a keyboard having a QWERTY arrangement of keys although other arrangements of keys are also contemplated. Further, other non-conventional configurations are also contemplated, such as a game controller, configuration to mimic a musical instrument, and so forth. Thus, the input device 104 and keys incorporated by the input device 104 may assume a variety of different configurations to support a variety of different functionality.

As previously described, the input device 104 is physically and communicatively coupled to the computing device 102 in this example through use of a flexible hinge 106. The flexible hinge 106 is flexible in that rotational movement supported by the hinge is achieved through flexing (e.g., bending) of the material forming the hinge as opposed to mechanical rotation as supported by a pin, although that embodiment is also contemplated. Further, this flexible rotation may be configured to support movement in one direction (e.g., vertically in the figure) yet restrict movement in other directions, such as lateral movement of the input device 104 in relation to the computing device 102. This may be used to support consistent alignment of the input device 104 in relation to the computing device 102, such as to align sensors used to change power states, application states, and so on.

The flexible hinge 106, for instance, may be formed using one or more layers of fabric and include conductors formed as flexible traces to communicatively couple the input device 104 to the computing device 102 and vice versa. This communication, for instance, may be used to communicate a result of a key press to the computing device 102, receive power from the computing device, perform authentication, provide supplemental power to the computing device 102, and so on. The flexible hinge 106 may be configured in a variety of ways, further discussion of which may be found in relation to the following figure.

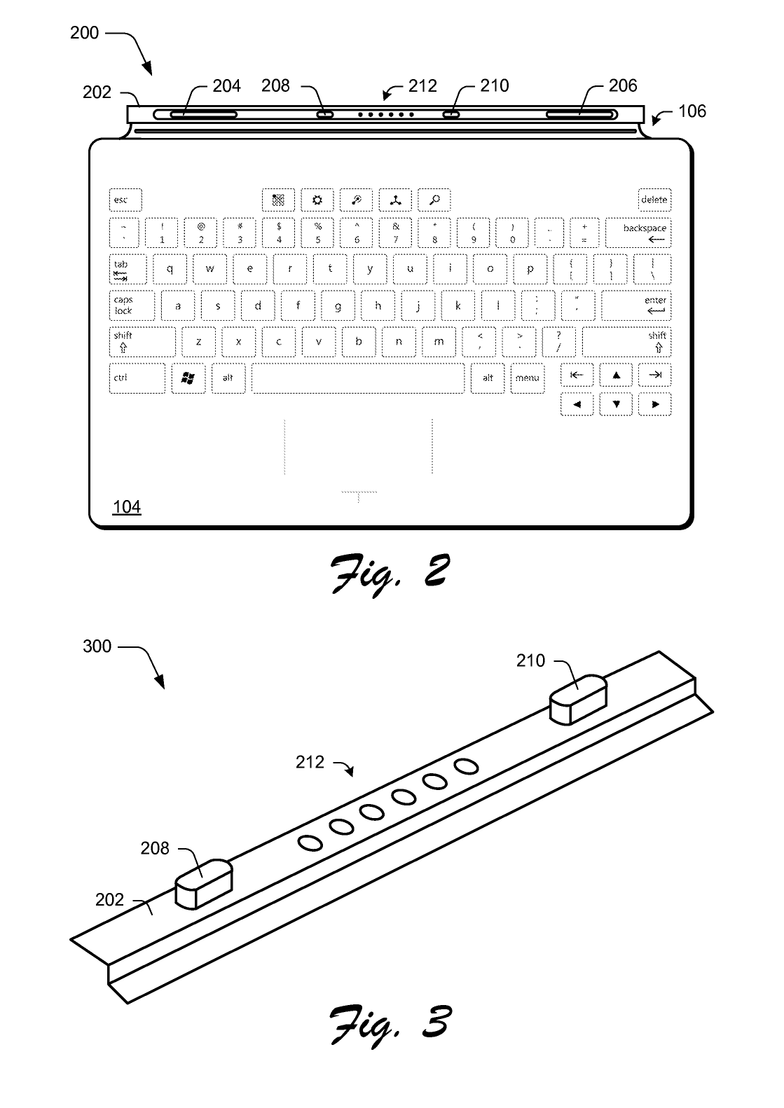

FIG. 2 depicts an example implementation 200 of the input device 104 of FIG. 1 as showing the flexible hinge 106 in greater detail. In this example, a connection portion 202 of the input device is shown that is configured to provide a communicative and physical connection between the input device 104 and the computing device 102. In this example, the connection portion 202 has a height and cross section configured to be received in a channel in the housing of the computing device 102, although this arrangement may also be reversed without departing from the spirit and scope thereof.

The connection portion 202 is flexibly connected to a portion of the input device 104 that includes the keys through use of the flexible hinge 106. Thus, when the connection portion 202 is physically connected to the computing device the combination of the connection portion 202 and the flexible hinge 106 supports movement of the input device 104 in relation to the computing device 102 that is similar to a hinge of a book.

For example, rotational movement may be supported by the flexible hinge 106 such that the input device 104 may be placed against the display device 110 of the computing device 102 and thereby act as a cover. The input device 104 may also be rotated so as to be disposed against a back of the computing device 102, e.g., against a rear housing of the computing device 102 that is disposed opposite the display device 110 on the computing device 102.

Naturally, a variety of other orientations are also supported. For instance, the computing device 102 and input device 104 may assume an arrangement such that both are laid flat against a surface as shown in FIG. 1. In another instance, a typing arrangement may be supported in which the input device 104 is laid flat against a surface and the computing device 102 is disposed at an angle to permit viewing of the display device 110, e.g., such as through use of a kickstand disposed on a rear surface of the computing device 102. Other instances are also contemplated, such as a tripod arrangement, meeting arrangement, presentation arrangement, and so forth.

The connecting portion 202 is illustrated in this example as including magnetic coupling devices 204, 206, mechanical coupling protrusions 208, 210, and a plurality of communication contacts 212. The magnetic coupling devices 204, 206 are configured to magnetically couple to complementary magnetic coupling devices of the computing device 102 through use of one or more magnets. In this way, the input device 104 may be physically secured to the computing device 102 through use of magnetic attraction.

The connecting portion 202 also includes mechanical coupling protrusions 208, 210 to form a mechanical physical connection between the input device 104 and the computing device 102. The mechanical coupling protrusions 208, 210 are shown in greater detail in the following figure.

FIG. 3 depicts an example implementation 300 shown a perspective view of the connecting portion 202 of FIG. 2 that includes the mechanical coupling protrusions 208, 210 and the plurality of communication contacts 212. As illustrated, the mechanical coupling protrusions 208, 210 are configured to extend away from a surface of the connecting portion 202, which in this case is perpendicular although other angles are also contemplated.

The mechanical coupling protrusions 208, 210 are configured to be received within complimentary cavities within the channel of the computing device 102. When so received, the mechanical coupling protrusions 208, 210 promote a mechanical binding between the devices when forces are applied that are not aligned with an axis that is defined as correspond to the height of the protrusions and the depth of the cavity.

For example, when a force is applied that does coincide with the longitudinal axis described previously that follows the height of the protrusions and the depth of the cavities, a user overcomes the force applied by the magnets solely to separate the input device 104 from the computing device 102. However, at other angles the mechanical coupling protrusion 208, 210 are configured to mechanically bind within the cavities, thereby creating a force to resist removal of the input device 104 from the computing device 102 in addition to the magnetic force of the magnetic coupling devices 204, 206. In this way, the mechanical coupling protrusions 208, 210 may bias the removal of the input device 104 from the computing device 102 to mimic tearing a page from a book and restrict other attempts to separate the devices.

The connecting portion 202 is also illustrated as including a plurality of communication contacts 212. The plurality of communication contacts 212 is configured to contact corresponding communication contacts of the computing device 102 to form a communicative coupling between the devices. The communication contacts 212 may be configured in a variety of ways, such as through formation using a plurality of spring loaded pins that are configured to provide a consistent communication contact between the input device 104 and the computing device 102. Therefore, the communication contact may be configured to remain during minor movement of jostling of the devices. A variety of other examples are also contemplated, including placement of the pins on the computing device 102 and contacts on the input device 104.

FIG. 4 depicts an example of a cross-sectional view of a pressure sensitive key 400 of a keyboard of the input device 104 of FIG. 2. The pressure sensitive key 400 in this example is illustrated as being formed using a flexible contact layer 402 (e.g., Mylar) that is spaced apart from the sensor substrate 404 using a spacer layer 406, 408, which may be formed as another layer of Mylar, formed on the sensor substrate 404, and so on. In this example, the flexible contact layer 402 does not contact the sensor substrate 404 absent application of pressure against the flexible contact layer 402.

The flexible contact layer 402 in this example includes a force sensitive ink 410 disposed on a surface of the flexible contact layer 402 that is configured to contact the sensor substrate 404. The force sensitive ink 410 is configured such that an amount of resistance of the ink varies directly in relation to an amount of pressure applied. The force sensitive ink 410, for instance, may be configured with a relatively rough surface that is compressed against the sensor substrate 404 upon an application of pressure against the flexible contact layer 402. The greater the amount of pressure, the more the force sensitive ink 410 is compressed, thereby increasing conductivity and decreasing resistance of the force sensitive ink 410. Other conductors may also be disposed on the flexible contact layer 402 without departing form the spirit and scope therefore, including other types of pressure sensitive and non-pressure sensitive conductors.

The sensor substrate 404 includes one or more conductors 412 disposed thereon that are configured to be contacted by the force sensitive ink 410 of the flexible contact layer 402. When contacted, an analog signal may be generated for processing by the input device 104 and/or the computing device 102, e.g., to recognize whether the signal is likely intended by a user to provide an input for the computing device 102. A variety of different types of conductors 412 may be disposed on the sensor substrate 404, such as formed from a variety of conductive materials (e.g., silver, copper), disposed in a variety of different configurations as further described below.

FIG. 5 depicts an example 500 of the pressure sensitive key 400 of FIG. 4 as having pressure applied at a first location of the flexible contact layer 402 to cause contact of the force sensitive ink 410 with a corresponding first location of the sensor substrate 404. The pressure is illustrated through use of an arrow in FIG. 5 and may be applied in a variety of ways, such as by a finger of a user's hand, stylus, pen, and the like. In this example, the first location at which pressure is applied as indicated by the arrow is located generally near a center region of the flexible contact layer 402 that is disposed between the spacer layers 406, 408. Due to this location, the flexible contact layer 402 may be considered generally flexible and thus responsive to the pressure.

This flexibility permits a relatively large area of the flexible contact layer 402, and thus the force sensitive ink 410, to contact the conductors 412 of the sensor substrate 404. Thus, a relatively strong signal may be generated. Further, because the flexibility of the flexible contact layer 402 is relatively high at this location, a relatively large amount of the force may be transferred through the flexible contact layer 402, thereby applying this pressure to the force sensitive ink 410. As previously described, this increase in pressure may cause a corresponding increase in conductivity of the force sensitive ink and decrease in resistance of the ink. Thus, the relatively high amount of flexibility of the flexible contact layer at the first location may cause a relatively stronger signal to be generated in comparison with other locations of the flexible contact layer 402 that located closer to an edge of the key, an example of which is described in relation to the following figure.

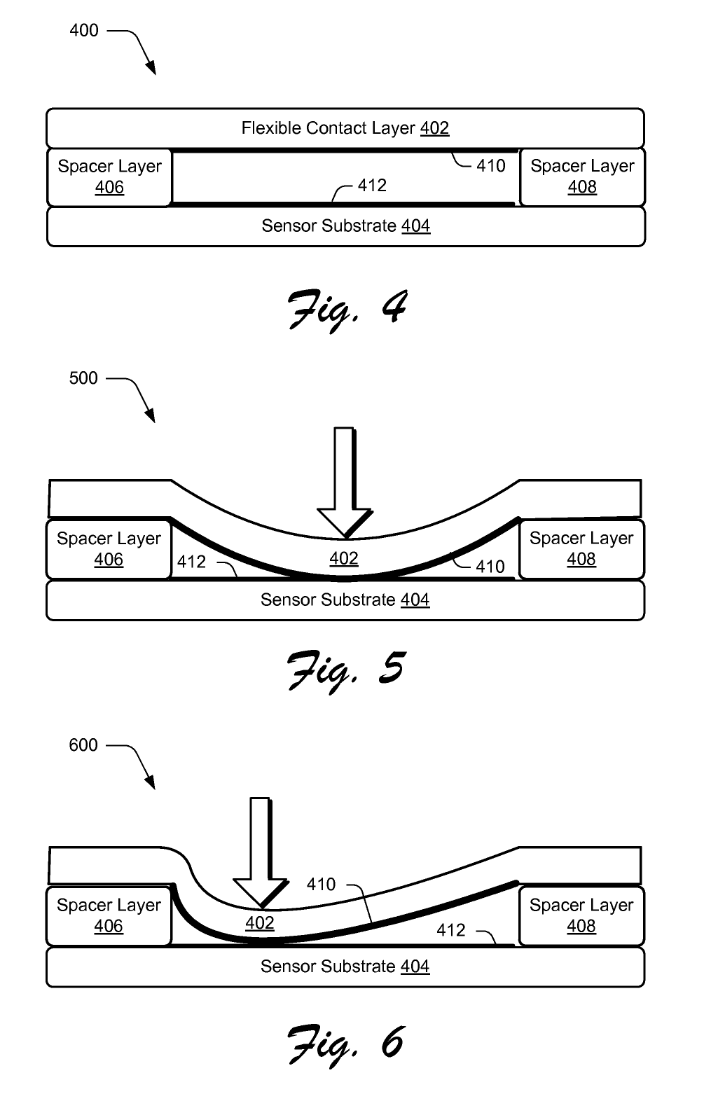

FIG. 6 depicts an example 600 of the pressure sensitive key 400 of FIG. 4 as having pressure applied at a second location of the flexible contact layer 402 to cause contact with a corresponding second location of the sensor substrate 404. In this example, the second location of FIG. 6 at which pressure is applied is located closer to an edge of the pressure sensitive key (e.g., closer to an edge of the spacer layer 406) than the first location of FIG. 5. Due to this location, the flexible contact layer 402 has reduced flexibility when compared with the first location and thus less responsive to pressure.

This reduced flexibility may cause a reduction in an area of the flexible contact layer 402, and thus the force sensitive ink 410, that contacts the conductors 412 of the sensor substrate 404. Thus, a signal produced at the second location may be weaker than a signal produced at the first location of FIG. 5.

Further, because the flexibility of the flexible contact layer 402 is relatively low at this location, a relatively low amount of the force may be transferred through the flexible contact layer 402, thereby reducing the amount of pressure transmitted to the force sensitive ink 410. As previously described, this decrease in pressure may cause a corresponding decrease in conductivity of the force sensitive ink and increase in resistance of the ink in comparison with the first location of FIG. 5. Thus, the reduced flexibility of the flexible contact layer 402 at the second location in comparison with the first location may cause a relatively weaker signal to be generated. Further, this situation may be exacerbated by a partial hit in which a smaller portion of the user's finger is able to apply pressure at the second location of FIG. 6 in comparison with the first location of FIG. 5.

However, as previously described techniques may be employed to normalize outputs produced by the switch at the first and second locations. This may be performed in a variety of ways, such as through configuration of the flexible contact layer 402 having various specialized zones, use of a plurality of sensors, and combinations thereof.

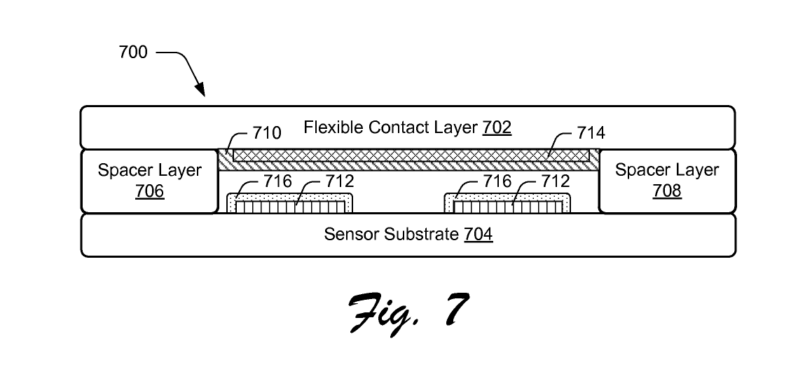

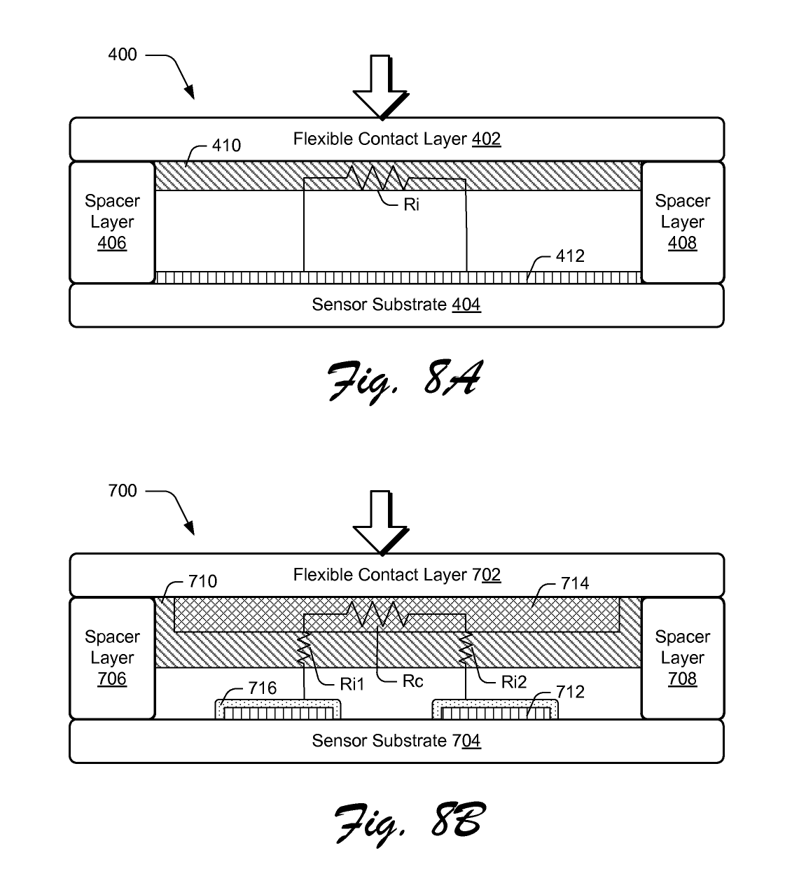

FIG. 7 depicts an example of a cross-sectional view of a pressure sensitive key 700 of a keyboard of the input device 104 shown in FIG. 2. The pressure sensitive key 700 in this example is illustrated as being fabricated, formed, or otherwise manufactured using a flexible contact layer 702 (e.g., Mylar) that is spaced apart from the sensor substrate 704 using a spacer layer 706, 708, which may be formed as another layer of Mylar, formed on the sensor substrate 704. In this example, the flexible contact layer 702 does not contact the sensor substrate 704 absent application of pressure against the flexible contact layer 702.

The flexible contact layer 702 includes a conductive layer 714 disposed or otherwise fabricated, formed, or manufactured on a surface of the flexible contact layer 702. In the example shown in FIG. 7, the conductive layer 714 is disposed on a bottom surface of the flexible contact layer 702 that makes contact with the substrate 704 under the application of pressure against a top surface of the flexible contact layer 702.

The conductive layer 714 may be fabricated using silver, copper, or any other conductive material known to a person of ordinary skill in the art using any known process known to a person of ordinary skill in the art. The conductive layer 714 may be screened, coated, sprayed, printed or applied in other conventional ways to the contact layer 702. The conductive layer 714 may be deposited as a thin layer or in a predetermined pattern. The term “layer” as used herein may include shapes such as cylinders, rectangles, squares or other shapes as may be required for a specific application. The conductive layer 714 may include a conductivity (or resistivity) that, unlike force sensitive ink 710, does not change with the application of pressure. Put differently, the conductive layer 714 may include a conductivity that is nearly constant under the application of pressure or in the absence of the application of pressure.

A force sensitive ink 710 may be disposed or otherwise fabricated, formed, or manufactured on a surface of the flexible contact layer 702. In the example shown in FIG. 7, the force sensitive ink 710 is fabricated on the bottom surface of the flexible contact layer 702. The force sensitive ink 710 may be fabricated to substantially enclose or surround the conductive layer 714 to avoid the conductive layer 714 contacting the conductors 712. The force sensitive ink 710 is configured such that a resistance of the ink varies directly in relation to an amount of pressure applied. Similar to the force sensitive ink 410, the force sensitive ink 710 may be configured with a relatively rough surface that is compressed against the sensor substrate 704 upon the application of pressure against the flexible contact layer 702. The greater the amount of pressure, the more the force sensitive ink 710 is compressed, thereby increasing conductivity and decreasing impedance of the force sensitive ink 710. Other conductors may also be disposed on the flexible contact layer 702 without departing form the spirit and scope therefore, including other types of pressure sensitive and non-pressure sensitive conductors. The force sensitive ink 710 may be screened, coated, sprayed, printed or applied in other conventional ways to the flexible contact layer 702. The force sensitive ink 710 may be deposited as a thin layer or in a predetermined pattern.

The sensor substrate 704 includes one or more conductors 712 disposed thereon that are configured to be contacted by the conductive layer 714 and by the force sensitive ink 710 of the flexible contact layer 402. Upon the application of pressure, the flexible contact layer 702, the conductive layer 714, and the force sensitive ink 710 may cooperatively flex in the direction of the pressure to contact the sensor substrate 704 generally and the conductors 712 specifically. When contacted, an analog signal may be generated for processing by the input device 104 and/or the computing device 102, e.g., to recognize whether the signal is likely intended by a user to provide an input for the computing device 102. A variety of different types of conductors 712 may be disposed on the sensor substrate 704, such as formed from a variety of conductive materials (e.g., silver, copper), disposed in a variety of different configurations.

FIG. 9 depicts an example of conductors 712 of a sensor substrate 704. Referring to FIG. 9, a first conductor 902 is inter-digitated or interlocked to a second conductor 904. Surface area, amount of conductors, and gaps between the conductors may be used to adjust sensitivity at different locations of the sensor substrate 704.

Referring back to FIG. 7, the sensor substrate 704 may optionally include a carbon layer 716 disposed to substantially cover the one or more conductors 712. The carbon layer 716 may be screened, coated, sprayed, printed, or applied in other conventional ways to the substrate 704. The carbon layer 716 may be deposited as a thin layer or in a predetermined pattern. The carbon layer 716, as the name implies, may comprise carbon or any other material known to a person of ordinary skill in the art applied in any manner to the substrate 704 known to a person of ordinary skill in the art. The carbon layer 716 smooths rough edges in the conductors 712 that may deteriorate the force sensitive ink 710 to thereby improve the general life and/or performance of pressure sensitive key 700.

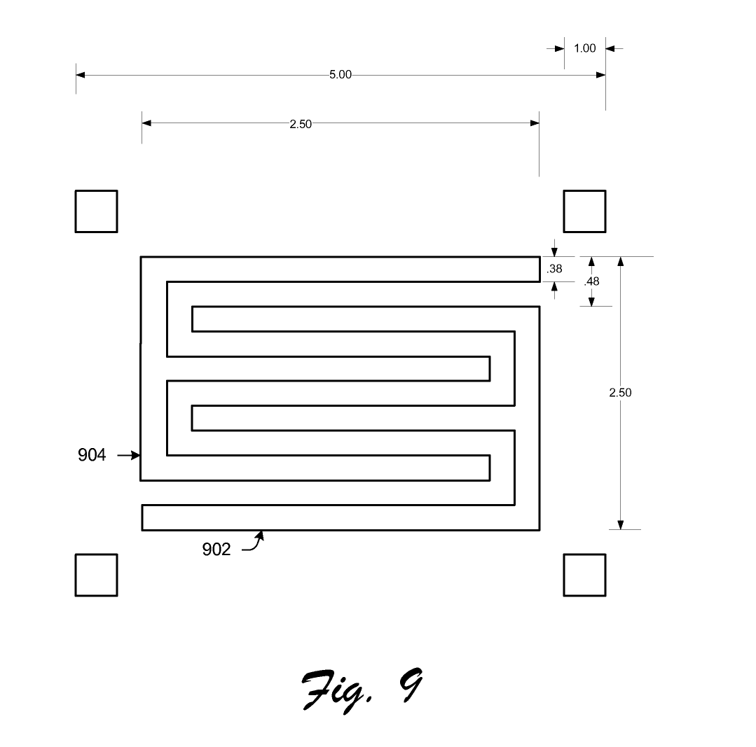

FIG. 8A depicts an example of a cross-sectional view of the pressure sensitive key 400 shown with the force sensitive ink 410 and the conductors 412 exaggerated to explain its operation. In FIG. 8A, the application of pressure is illustrated through the use of an arrow and may be applied in a variety of ways, such as by a user's hand, stylus, pen, and the like. The force sensitive ink 410 is configured such that an amount of resistance of the ink varies directly in relation to an amount of pressure applied. As explained previously, the greater the amount of pressure, the more the force sensitive ink 410 is compressed increasing contact surface area between the granules suspended in the force sensitive ink 410. The greater contact surface area between granules creates more efficient paths for electrical flow between conductors 412. The force sensitive ink 410, therefore, increases its conductivity and decreases its impedance Ri between conductors 412. The signal created using the pressure sensitive key 400 is dependent on area and pressure because the impedance Ri varies dependent on area and pressure as we explained above relative to FIGS. 5 and 6.

FIG. 8B depicts an example of a cross-sectional view of the pressure sensitive key 700 shown with the conductive layer 714 and the force sensitive ink 710 exaggerated to explain its operation. As explained above, the conductive layer 714 may include an impedance Rc that, unlike force sensitive ink 710, remains constant with the application of pressure. As explained above, the greater the amount of pressure applied to the contact layer 702, the more the force sensitive ink 710 is compressed, thereby increasing the conductivity and decreasing the impedance Ri1 and impedance Ri2. Unlike the pressure sensitive key 400, the pressure sensitive key 700 is less dependent on the area and pressure because the impedance Rc of the conductive layer 714 is substantially constant, remaining unaffected with changes in the area or amount of pressure applied. The result is that the pressure sensitive key 700 presents impedance Ri1+Rc+Ri2 to electrical flow that is less dependent on the variations of the force sensitive ink 710 to improve accuracy and increase linearity of the resulting signal. The pressure sensitive key 700, like key 400, is considered single-sided because the conductors 712 are on a single side of the force sensitive ink 710 and 410, respectively. The pressure sensitive key 400 operates in a shunt mode where the electrical path is formed between the conductors 412 through the impedance Ri of the force sensitive ink 410. By contrast, the addition of conductive layer 714, allows the pressure sensitive key 700 to operate in a hybrid shunt/thru mode where the electrical path includes the conductors 712 through the impedance Rc of the conductive layer 714 as well as impedances Ri1 and Ri2 of the force sensitive ink 710. The pressure sensitive key 700, therefore, relies primarily on the ink impedance Ri1 and Ri2 for varied signal response while the pressure sensitive key 400 relies on primarily on the ink impedance Ri plus the area of activation and position for varied signal response. The addition of the conductive layer 714 applied directly under the force sensitive ink layer 710 used with shunt sensor design (FIG. 9) avoids the additional cost and manufacturing complexity associated with double-sided devices that include conductors on both sides of the force sensitive ink 710, which typically require interconnection therebetween.

### Example System and Device

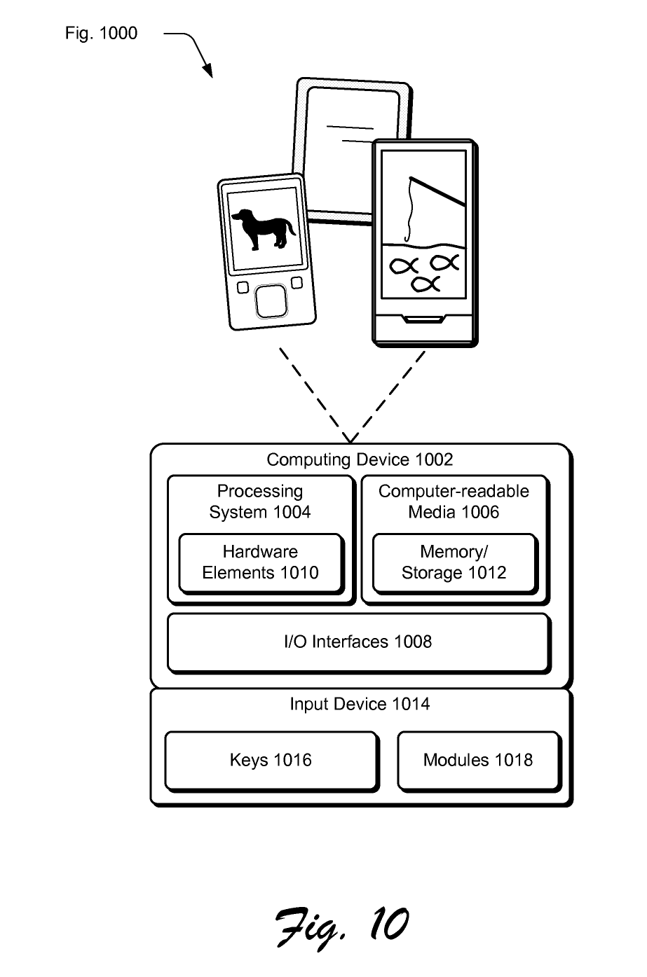

FIG. 10 illustrates an example system generally at 1000 that includes an example computing device 1002 that is representative of one or more computing systems and/or devices that may implement the various techniques described herein. The computing device 1002 may be, for example, be configured to assume a mobile configuration through use of a housing formed and size to be grasped and carried by one or more hands of a user, illustrated examples of which include a mobile phone, mobile game and music device, and tablet computer although other examples are also contemplated.

The example computing device 1002 as illustrated includes a processing system 1004, one or more computer-readable media 1006, and one or more I/O interface 1008 that are communicatively coupled, one to another. Although not shown, the computing device 1002 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1004 is representative of functionality to perform one or more operations using hardware. Accordingly, the processing system 1004 is illustrated as including hardware element 1010 that may be configured as processors, functional blocks, and so forth. This may include implementation in hardware as an application specific integrated circuit or other logic device formed using one or more semiconductors. The hardware elements 1010 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 1006 is illustrated as including memory/storage 1012. The memory/storage 1012 represents memory/storage capacity associated with one or more computer-readable media. The memory/storage component 1012 may include volatile media (such as random access memory (RAM)) and/or nonvolatile media (such as read only memory (ROM), Flash memory, optical disks, magnetic disks, and so forth). The memory/storage component 1012 may include fixed media (e.g., RAM, ROM, a fixed hard drive, and so on) as well as removable media (e.g., Flash memory, a removable hard drive, an optical disc, and so forth). The computer-readable media 1006 may be configured in a variety of other ways as further described below.

Input/output interface(s) 1008 are representative of functionality to allow a user to enter commands and information to computing device 1002, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1002 may be configured in a variety of ways to support user interaction.

The computing device 1002 is further illustrated as being communicatively and physically coupled to an input device 1014 that is physically and communicatively removable from the computing device 1002. In this way, a variety of different input devices may be coupled to the computing device 1002 having a wide variety of configurations to support a wide variety of functionality. In this example, the input device 1014 includes one or more keys 1016, which may be configured as pressure sensitive keys, mechanically switched keys, and so forth.

The input device 1014 is further illustrated as include one or more modules 1018 that may be configured to support a variety of functionality. The one or more modules 1018, for instance, may be configured to process analog and/or digital signals received from the keys 1016 to determine whether a keystroke was intended, determine whether an input is indicative of resting pressure, support authentication of the input device 1014 for operation with the computing device 1002, and so on.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1002. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 1002, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1010 and computer-readable media 1006 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 1010. The computing device 1002 may be configured to implement particular instructions and/or functions corresponding to the software and/or hardware modules. Accordingly, implementation of a module that is executable by the computing device 1002 as software may be achieved at least partially in hardware, e.g., through use of computer-readable storage media and/or hardware elements 1010 of the processing system 1004. The instructions and/or functions may be executable/operable by one or more articles of manufacture (for example, one or more computing devices 1002 and/or processing systems 1004) to implement techniques, modules, and examples described herein.

### CONCLUSION

Although the example implementations have been described in language specific to structural features and/or methodological acts, it is to be understood that the implementations defined in the appended claims is not necessarily limited to the specific features or acts described. Rather, the specific features and acts are disclosed as example forms of implementing the claimed features.

A person of ordinary skill in the art will recognize that they may make many changes to the details of the above-described exemplary systems and methods without departing from the underlying principles. Only the following claims, therefore, define the scope of the exemplary systems and methods.

1. A direct conduction sensor, comprising:
a sensor substrate;
a conductive layer fabricated on a bottom surface of a contact layer; and
a force sensing layer fabricated on the bottom surface of the contact layer substantially surrounding the conductive layer;
wherein the contact layer, the conductive layer, and the force sensing layer are configured to cooperatively flex in response to an application of pressure to contact the sensor substrate.

2. The direct conduction sensor of claim 1, wherein the sensor substrate comprises a first conductor or a second conductor or a combination of both.

3. The direct conduction sensor of claim 2, wherein the contact layer, the conductive layer, and the force sensing layer are configured to cooperatively flex in response to the application of pressure to contact the first conductor or the second conductor or the combination of the first conductor and the second conductor.

4. The direct conduction sensor of claim 2, further comprising a carbon layer fabricated to substantially surround the first conductor or the second conductor.

5. The direct conduction sensor of claim 1, further comprising a spacer layer configured to space apart the contact layer from the sensor substrate in an absence of the application of pressure.

6. The direct conduction sensor of claim 1, wherein the force sensing layer comprises a force sensing ink having a first conductivity under the application of pressure.

7. The direct conduction sensor of claim 6, wherein the conductive layer comprises a second conductivity higher than the first conductivity.

8. An input device, comprising:
a substrate;
a contact layer spaced apart from the substrate;
a conductive layer formed on an underside of the contact layer;
a sensing layer formed on the underside of the contact layer substantially surrounding the conductive layer;
wherein the contact layer, the conductive layer, and the sensing layer are configured to cooperatively flex in response to pressure to thereby contact the substrate.

9. The input device of claim 8, wherein the substrate comprises a first conductor or a second conductor or a combination of both.

10. The input device of claim 9, wherein the contact layer, the conductive layer, and the sensing layer are configured to cooperatively flex in response to the pressure to contact the first conductor or the second conductor or the combination of the first conductor and the second conductor.

11. The input device of claim 9, further comprising a carbon layer formed to substantially surround the first conductor or the second conductor.

12. The input device of claim 8, further comprising a spacer layer configured to space apart the contact layer from the substrate in an absence of the pressure.

13. The input device of claim 8, wherein the sensing layer comprises a force sensing ink having a first conductivity.

14. The input device of claim 13, wherein the conductive layer comprises a second conductivity higher than the first conductivity.

15. A keyboard, comprising:
a plurality of pressure sensitive keys configured to initiate inputs of a computing device, each of the plurality of pressure sensitive keys comprising:
a substrate;
a contact layer spaced apart from the substrate;
a conductive layer disposed on an bottom side of the contact layer;
a sensing layer disposed on the bottom of the contact layer substantially surrounding the conductive layer;
wherein the contact layer is configured to flex in response to an application of force to contact the substrate.

16. The keyboard of claim 15, wherein the substrate comprises at least one conductor disposed on an upper side of the substrate.

17. The keyboard of claim 16, wherein the contact layer, the conductive layer, and the sensing layer are configured to cooperatively flex in response to the application of force to contact the at least one conductor.

18. The keyboard of claim 16, wherein a carbon layer is manufactured on the upper side of the substrate to substantially enclose the at least one conductor.

19. The keyboard of claim 15, wherein the sensing layer comprises a force sensing ink having a first conductivity.

20. The keyboard of claim 15, wherein the conductive layer comprises a second conductivity higher than the first conductivity.
